(19) United States
(12) Patent Application Publication
(10) Pub. No.: US 2016/0031340 A1
(43) Pub. Date: Feb. 4, 2016

(54) METHOD TO DETERMINE THE RUNNING STATE OF A COOLANT PUMP IN A BATTERY THERMAL MANAGEMENT SYSTEM FOR AN ELECTRIFIED VEHICLE

(71) Applicant: FORD GLOBAL TECHNOLOGIES, LLC, DEARBORN, MI (US)

(72) Inventor: Angel Fernando Porras, Dearborn, MI (US)

(21) Appl. No.: 14/446,477

(22) Filed: Jul. 30, 2014

(51) Int. Cl. B60L 11/18; H01M 10/625; H01M 10/663; H01M 10/613

(52) U.S. Cl. CPC B60L 11/1874; H01M 10/613; H01M 10/625; H01M 10/663; H01M 2220/20

(57) ABSTRACT

A method according to an exemplary aspect of the present disclosure includes, among other things, controlling a thermal management system of an electrified vehicle in a chiller mode to determine a running state of a coolant pump of the thermal management system.

### TECHNICAL FIELD

This disclosure relates to a high voltage battery thermal management system for an electrified vehicle. The thermal management system can be operated in a chiller mode to determine a running state of a coolant pump of the thermal management system during certain conditions.

### BACKGROUND

The need to reduce fuel consumption and emissions in automobiles and other vehicles is well known. Therefore, vehicles are being developed that reduce reliance or completely eliminate reliance on internal combustion engines. Electrified vehicles are one type of vehicle currently being developed for this purpose. In general, electrified vehicles differ from conventional motor vehicles in that they are selectively driven by one or more battery powered electric machines. Conventional motor vehicles, by contrast, rely exclusively on the internal combustion engine to drive the vehicle.

Many electrified vehicles include thermal management systems that mange the thermal demands of various components during vehicle operation, including the vehicle's high voltage traction battery pack. Some thermal management systems provide active heating or active cooling of the battery pack as part of a liquid cooled system. It is desirable to improve the system management and operation of electrified vehicle thermal management systems.

### SUMMARY

A method according to an exemplary aspect of the present disclosure includes, among other things, controlling a thermal management system of an electrified vehicle in a chiller mode to determine a running state of a coolant pump of the thermal management system.

In a further non-limiting embodiment of the foregoing method, the controlling step is performed in response to an electrical circuit fault.

In a further non-limiting embodiment of either of the foregoing methods, the electrical circuit fault includes detecting a short to ground or an open circuit.

In a further non-limiting embodiment of any of the foregoing methods, the method includes determining whether a battery temperature sensor and a coolant temperature sensor of the thermal management system are valid and saving an initial battery temperature value and an initial coolant temperature value.

Nom In a further non-limiting embodiment of any of the foregoing methods, controlling the thermal management system in the chiller mode includes circulating a portion of a coolant through a chiller loop, commanding a coolant pump ON and opening a control valve to permit chilled coolant from the chiller loop to enter into an inlet of a battery pack.

In a further non-limiting embodiment of any of the foregoing methods, the controlling step includes operating the thermal management system in the chiller mode for a threshold amount of time and ending the chiller mode after the threshold amount of time has passed.

In a further non-limiting embodiment of any of the foregoing methods, the method includes comparing an actual battery temperature profile to an expected battery temperature profile and comparing an actual coolant temperature profile to an expected coolant temperature profile.

In a further non-limiting embodiment of any of the foregoing methods, the method includes calculating an actual battery temperature area associated with the actual battery temperature profile, calculating a difference between the actual battery temperature area and an expected battery temperature area, calculating an actual coolant temperature area associated with the actual coolant temperature profile and calculating a difference between the actual coolant temperature area and an expected coolant temperature area.

In a further non-limiting embodiment of any of the foregoing methods, the method includes determining that the coolant pump is OFF if a difference between the actual battery temperature area and the expected battery temperature area exceeds a battery temperature threshold difference and a difference between the actual coolant temperature area and the expected coolant temperature area is less than a coolant temperature threshold difference.

In a further non-limiting embodiment of any of the foregoing methods, the method includes determining that the coolant pump is ON if a difference between the actual battery temperature area and the expected battery temperature area does not exceed a battery temperature threshold difference or a difference between the actual coolant temperature area and the expected coolant temperature area is not less than a coolant temperature threshold difference.

In a further non-limiting embodiment of any of the foregoing methods, the actual battery temperature area and the actual coolant temperature area are calculated by performing discrete integration over a threshold amount of time.

A method according to another exemplary aspect of the present disclosure includes, among other things, operating a coolant subsystem of a thermal management system of an electrified vehicle in a chiller mode, comparing an actual battery temperature profile to an expected battery temperature profile, comparing an actual coolant temperature profile to an expected coolant temperature profile and determining a running state of a coolant pump of the coolant subsystem based on the comparing steps.

In a further non-limiting embodiment of the foregoing method, the operating step includes circulating a portion of a coolant through a chiller loop of the coolant subsystem, commanding the coolant pump ON and opening a control valve of the coolant subsystem to permit chilled coolant from the chiller loop to be communicated to an inlet of a battery pack.

In a further non-limiting embodiment of either of the foregoing methods, comparing the actual battery temperature profile to the expected battery temperature profile includes integrating the actual battery temperature profile to calculate an actual battery temperature area associated with the actual battery temperature profile and calculating a difference between the actual battery temperature area and an expected battery temperature area.

In a further non-limiting embodiment of any of the foregoing methods, comparing the actual coolant temperature profile to the expected coolant temperature profile includes integrating the actual coolant temperature profile to calculate an actual coolant temperature area associated with the actual coolant temperature profile and calculating a difference between the actual coolant temperature area and an expected coolant temperature area.

In a further non-limiting embodiment of any of the foregoing methods, the determining step includes determining that the coolant pump is OFF if a difference between an actual battery temperature area and an expected battery temperature area exceeds a battery temperature threshold difference and a difference between an actual coolant temperature area and an expected coolant temperature area is less than a coolant temperature threshold difference, or determining that the coolant pump is ON if a difference between the actual battery temperature area and the expected battery temperature area does not exceed the battery temperature threshold difference or the difference between the actual coolant temperature area and the expected coolant temperature area is not less than the coolant temperature threshold difference.

A thermal management system according to another exemplary aspect of the present disclosure includes, among other things, a battery pack, a coolant subsystem that circulates a coolant to thermally manage the battery pack, the coolant subsystem including a radiator, a coolant pump and a chiller loop and a control module configured to operate the coolant subsystem in a chiller mode to determine a running state of the coolant pump.

In a further non-limiting embodiment of the foregoing system, the coolant subsystem includes a valve that controls a flow of a chilled coolant from the chiller loop to the battery pack.

In a further non-limiting embodiment of either of the foregoing systems, the chiller loop includes a chiller.

In a further non-limiting embodiment of any of the foregoing systems, a refrigerant subsystem exchanges heat with the coolant subsystem within the chiller loop.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a high voltage battery thermal management system of an electrified vehicle.

FIG. 3 schematically illustrates a control strategy for controlling a high voltage battery thermal management system of an electrified vehicle to determine a coolant pump running state.

FIG. 4 is a graphical representation of actual and expected battery temperature and coolant temperature profiles during a coolant pump failure.

FIG. 5 is a graphical representation of actual battery temperature and coolant temperature areas calculated based on actual battery and coolant temperature profiles during a coolant pump failure.

FIG. 6 is a graphical representation of expected battery temperature and coolant temperature areas calculated based on expected battery and coolant temperature profiles during normal coolant pump operation.

### DETAILED DESCRIPTION

This disclosure relates to a system and method for determining a coolant pump running state of an electrified vehicle high voltage battery thermal management system. The thermal management system may be operated in a chiller mode to determine a running state of the coolant pump of the system during certain conditions. Actual battery and coolant temperature profiles are evaluated and compared to expected battery and coolant temperature profiles to determine a running state (i.e., ON or OFF) of the coolant pump. These and other features are discussed in greater detail in the paragraphs that follow.

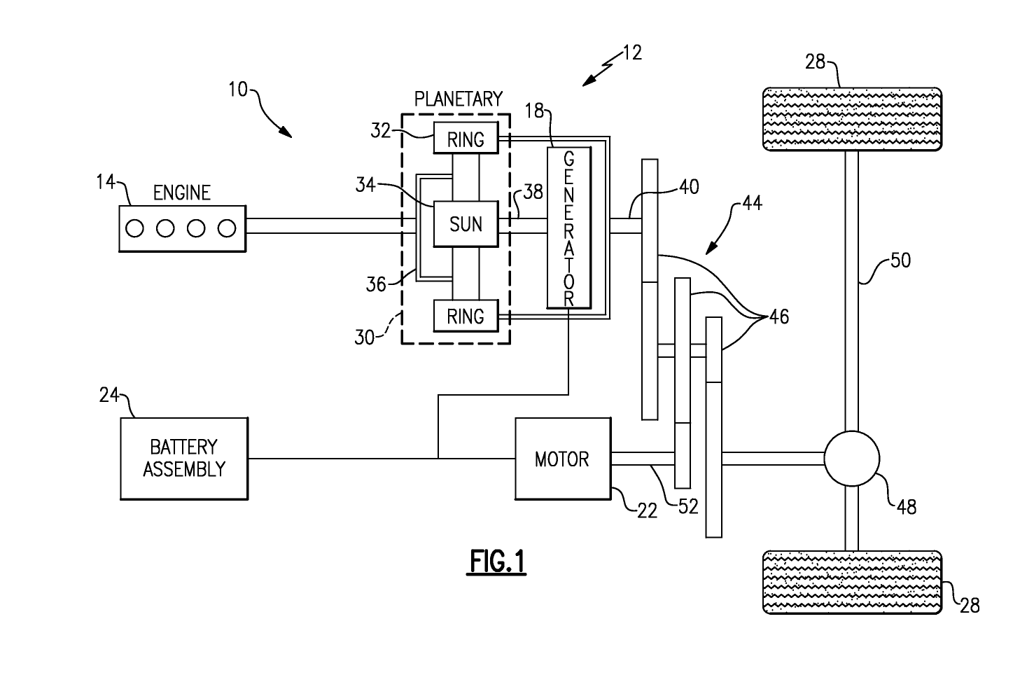

FIG. 1 schematically illustrates a powertrain 10 for an electrified vehicle 12. Although depicted as a hybrid electric vehicle (HEV), it should be understood that the concepts described herein are not limited to HEV's and could extend to other electrified vehicles, including, but not limited to, plug-in hybrid electric vehicles (PHEV's), battery electric vehicles (BEV's), and modular hybrid transmission vehicles (MHT's).

In one embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery assembly 24. In this example, the second drive system is considered an electric drive system of the powertrain 10. The first and second drive systems generate torque to drive one or more sets of vehicle drive wheels 28 of the electrified vehicle 12. Although a power-split configuration is shown, this disclosure extends to any hybrid or electric vehicle including full hybrids, parallel hybrids, series hybrids, mild hybrids or micro hybrids.

The engine 14, which could include an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery assembly 24.

The battery assembly 24 is an exemplary type of electrified vehicle battery assembly. The battery assembly 24 may include a high voltage battery pack that includes a plurality of battery arrays capable of outputting electrical power to operate the motor 22 and the generator 18. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery assembly 24 state of charge up to its maximum allowable discharging rate under certain driving patterns/cycles. The EV mode is an example of a charge depleting mode of operation for the electrified vehicle 12. During EV mode, the state of charge of the battery assembly 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery assembly 24 at a constant or approximately constant level by increasing the engine 14 propulsion usage. The electrified vehicle 12 may be operated in other operating modes in addition to the EV and HEV modes within the scope of this disclosure.

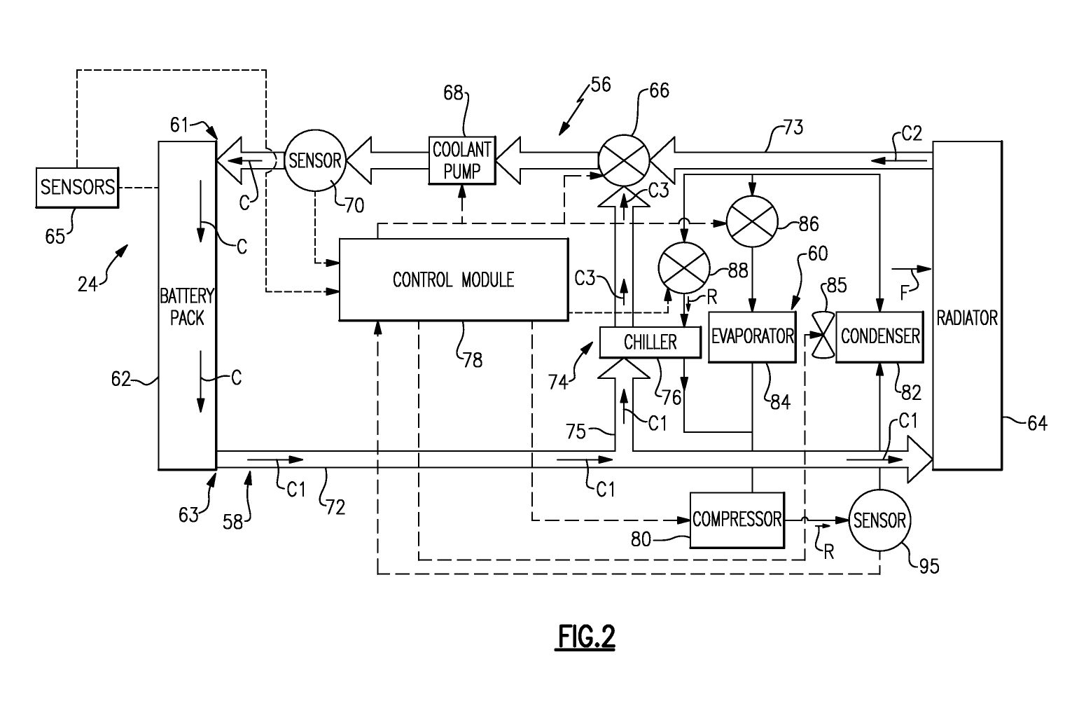

FIG. 2 illustrates a high voltage battery thermal management system 56 of an electrified vehicle, such as the electrified vehicle 12 of FIG. 1. However, this disclosure extends to other electrified vehicles and is not limited to the specific configuration shown in FIG. 1. In FIG. 2, devices and fluidic passages or conduits are shown in solid lines, and electrical connections are illustrated using dashed lines.

The thermal management system 56 can be employed to manage thermal loads generated by various vehicle components, such as the battery assembly 24. For example, the thermal management system 56 can selectively communicate coolant to the battery assembly 24 to either cool or heat the battery assembly 24, depending on ambient conditions and/or other conditions. In one embodiment, the thermal management system 56 includes a coolant subsystem 58 and a refrigerant subsystem 60. Each of these subsystems is described in detail below.

The coolant subsystem 58, or coolant loop, may circulate a coolant C to the battery assembly 24. The coolant C may be a conventional type of coolant mixture, such as water mixed with ethylene glycol. Other coolants could also be used by the thermal management system 56. In one non-limiting embodiment, the coolant C of the coolant subsystem 58 may be used to thermally manage a battery pack 62 of the battery assembly 24. Although not shown, the battery pack 62 may include a plurality of battery cells that generate heat during operation. Other vehicle components may alternatively or additionally be conditioned by the thermal management system 56.

In one non-limiting embodiment, the coolant subsystem 58 of the thermal management system 56 includes a radiator 64, a valve 66, a coolant pump 68, a sensor 70, the battery pack 62, and a chiller 76. Additional components may be employed by the coolant subsystem 58. The valve 66, the coolant pump 68 and the sensor 70 may be located between the battery pack 62 and the radiator 64, in one embodiment.

In operation, warm coolant C1 may exit an outlet 63 of the battery pack 62. The warm coolant C1 is communicated to the radiator 64 within line 72. The warm coolant C1 is cooled within the radiator 64. In one embodiment, airflow F may be communicated across the radiator 64 to effectuate heat transfer between the airflow and the warm coolant C1. Cool coolant C2 may exit the radiator 64 and enter line 73.

The cool coolant C2 is next communicated to the valve 66. In one embodiment, the valve 66 is an electrically operated valve that is selectively actuated via a control module 78 to control flow of the coolant C. Other types of valves could alternatively be utilized within the coolant subsystem 58.

The coolant pump 68 circulates the coolant C through the coolant subsystem 58. The coolant pump 68 may be powered by electrical or non-electrical power sources. In one embodiment, the coolant pump 68 is positioned between the valve 66 and the sensor 70 within line 73.

The sensor 70 may be positioned near an inlet 61 of the battery pack 62. The sensor 70 is configured to monitor the temperature of the coolant C that is returned to the battery pack 62. In one embodiment, the sensor 70 is a temperature sensor.

The battery pack 62 may also include one more sensors 65. The sensors 65 monitor the temperatures of various battery cells (not shown) of the battery pack 62. Like the sensor 70, the sensors 65 may be temperature sensors.

The coolant subsystem 58 may additionally include a chiller loop 74. The chiller loop 74 includes the chiller 76 for providing a chilled coolant C3 during certain conditions. For example, when an ambient temperature exceeds a predefined threshold, the valve 66 may be actuated to allow the chilled coolant C3 from the chiller loop 74 to flow into the line 73. A portion of the warm coolant C1 from the battery pack 62 may enter the chiller loop 74 in bypass line 75 and exchange heat with a refrigerant R of the refrigerant subsystem 60 within the chiller 76 to render the chilled coolant C3 during a chiller mode. In other words, the chiller 76 may facilitate the transfer of thermal energy between the coolant subsystem 58 and the refrigerant subsystem 60 during the chiller mode. During the chiller mode, the valve 66 is actuated ON, it blocks flow from the radiator 64 and all coolant flow to the battery pack 62 is from the chiller loop 74. Conversely, when the valve is actuated OFF, all coolant flow to the battery pack 62 is from the radiator 64.

The refrigerant subsystem 60, or refrigerant loop, may include a compressor 80, a condenser 82, an evaporator 84, the chiller 76, a first expansion device 86 and a second expansion device 88. The compressor 80 pressurizes and circulates the refrigerant R through the refrigerant subsystem 60. The compressor 80 may be powered by an electrical or non-electrical power source. A pressure sensor 95 may monitor the pressure of the refrigerant R exiting the compressor 80.

Refrigerant R exiting the compressor 80 may be communicated to the condenser 82. The condenser 82 transfers heat to the surrounding environment by condensing the refrigerant R from a vapor to a liquid. A blower fan 85 may be selectively actuated to communicate an airflow across the condenser 82 to effectuate heat transfer between the refrigerant R and the airflow.

A portion of the liquid refrigerant R that exits the condenser 82 may be communicated through the first expansion device 86 and then to the evaporator 84. The first expansion device 86 is adapted to change the pressure of the refrigerant R. In one non-limiting embodiment, the first expansion device 86 is an electronically controlled expansion valve (EXV). In another embodiment, the first expansion device 86 is a thermal expansion valve (TXV). The liquid refrigerant R is vaporized from liquid to gas, while absorbing heat, within the evaporator 84. The gaseous refrigerant R may then return to the compressor 80. Alternatively, the first expansion device 86 may be closed to bypass the evaporator 84.

Another portion of the liquid refrigerant R exiting the condenser 82 (or all of the refrigerant R if the first expansion device 86 is closed) may circulate through the second expansion device 88 and enter the chiller 76. The second expansion device 88, which may also be an EXV or TXV, is adapted to change the pressure of the refrigerant R. The refrigerant R exchanges heat with the warm coolant C1 within the chiller 76 to provide the chilled coolant C3 during the chiller mode.

The thermal management system 56 may additionally include a control module 78. While schematically illustrated as a single module in the illustrated embodiment, the control module 78 may be part of a larger control system and may be controlled by various other controllers throughout an electrified vehicle, such as a vehicle system controller (VSC) that includes a power train control unit, a transmission control unit, an engine control unit, a BECM, etc. It should therefore be understood that the control module 78 and one or more other controllers can collectively be referred to as “a control module” that controls, such as through a plurality of integrated algorithms, various actuators in response to signals from various sensors to control functions associated with the vehicle, and in this case, with a thermal management system 56. The various controllers that make up the VSC can communicate with one another using a common bus protocol (e.g., CAN).

In one non-limiting embodiment, the control module 78 can control operation of the coolant subsystem 58 and refrigerant subsystem 60 to achieve desired heating and/or cooling of the battery pack 62. For example, the control module 78 may control or be in communication with the valve 66, the coolant pump 68, the sensor 70, the sensors 65, the compressor 80, the pressure sensor 95, the blower fan 85, the first expansion device 86 and the second expansion device 88, among other components. The control module 78 may also determine a running state of the coolant pump 68, as is further discussed below.

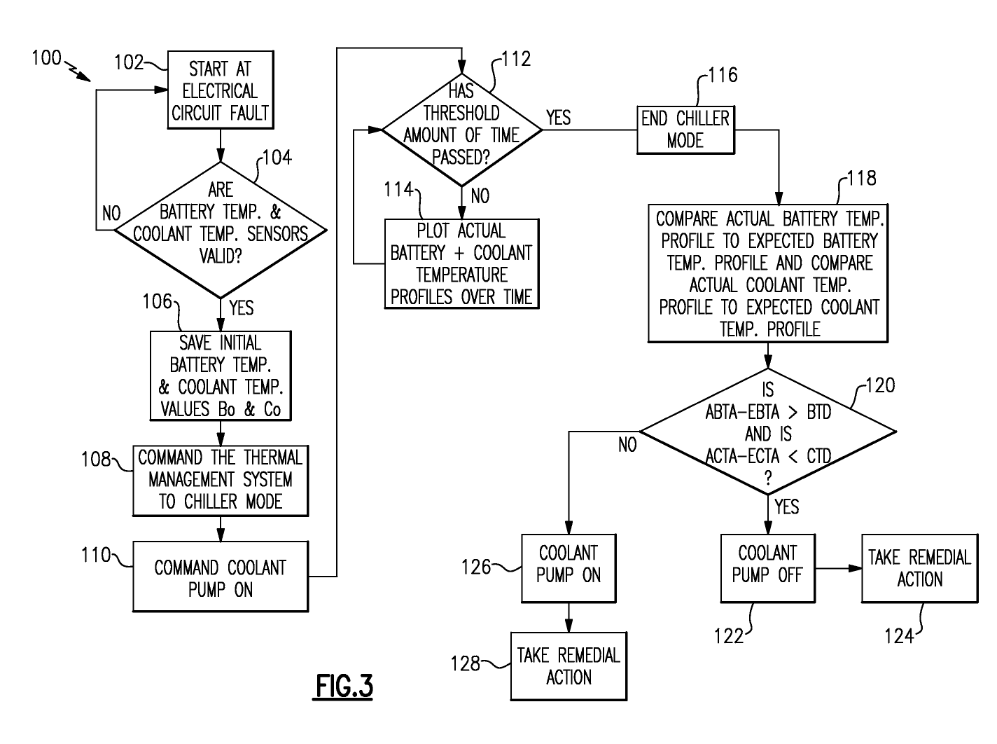

FIG. 3, with continued reference to FIGS. 1 and 2, schematically illustrates a control strategy 100 for controlling operation of the thermal management system 56 of the electrified vehicle 12. For example, the control strategy 100 may be executed during certain conditions to determine a running state of the coolant pump 68 of the coolant subsystem 58. Of course, the electrified vehicle 12 is capable of implementing and executing other control strategies within the scope of this disclosure. In one embodiment, the control module 78 of the thermal management system 56 is programmed with one or more algorithms adapted to execute the control strategy 100, or any other control strategy. In other words, the control strategy 100 may be stored as executable instructions in the non-transitory memory of the control module 78, in one non-limiting embodiment.

As shown in FIG. 3, the control strategy 100 may begin at block 102 in response to sensing an electrical circuit fault. The electrical circuit fault may be caused by a short to ground or an open circuit, in which case the control module 78 cannot distinguish between different failure modes of the coolant pump 68. Therefore, the pump running state cannot be readily determined without employing the control strategy 100.

Next, at block 104, the control strategy 100 may determine whether the sensors 65 and sensor 70 (i.e., the battery and coolant temperature sensors) are valid, or functioning properly. In one embodiment, the control module 78 determines whether the sensors 65, 70 are valid by assessing whether the temperature readings of the sensors 65, 70 are within predefined threshold temperature ranges. The predefined threshold temperature ranges of both the battery pack 62 and the coolant C may be saved in the memory of the control module 78, such as within a look-up table, for example. If valid, the control strategy 100 may proceed to block 106 by saving an initial battery temperature value B₀ and an initial coolant temperature value C₀. Alternatively, if the sensors 65, 70 are found to be invalid, the control strategy 100 may return to block 102.

Next, at block 108, the thermal management system 56 is commanded to operate in the chiller mode. In the chiller mode, the valve 66 is actuated ON and chilled coolant C3 from the chiller loop 74 is permitted to flow into line 73 for communication to the battery pack 62. A portion of the warm coolant C1 enters the chiller loop 74 and exchanges heat with the refrigerant R of the refrigerant subsystem 60 within the chiller 76 to render the chilled coolant C3 during the chiller mode. The coolant pump 68 is commanded full ON (e.g., 100% duty cycle) at block 110.

The thermal management system 56 is operated in chiller mode for a threshold amount of time t_{f} The threshold amount of time t_{f} may be set at any amount of time but must be long enough to monitor any temperature rises of the battery pack 62 and temperature drops of the coolant C. In one non-limiting embodiment, the threshold amount of time t_{f} is programmed as approximately 120 seconds, although the chiller mode could be run for any amount of time. The threshold amount of time t_{f} may be monitored by a timer of the control module 78.

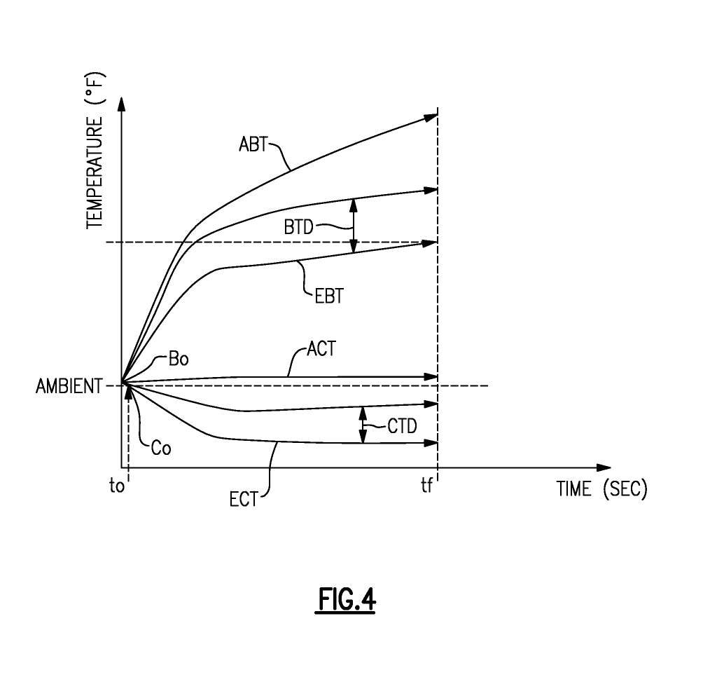

Next, at block 112, the control strategy 100 determines whether the threshold amount of time t_{f} has passed. If the threshold amount of time t_{f} has not yet passed, the control strategy 100 may proceed to block 114 by plotting an actual battery temperature profile ABT and an actual coolant temperature profile ACT between time t₀ and t_{f} (see FIG. 4). The actual battery temperature profile ABT and the actual coolant temperature profile ACT will be compared to an expected battery temperature profile EBT and an expected coolant temperature profile ECT, respectively, to determine the running state of the coolant pump 68, as discussed in greater detail below. In one embodiment, the actual battery temperature profile ABT may be plotted based on temperature readings from the sensors 65 and the actual coolant temperature profile ACT may be plotted based on temperature readings from the sensor 70, including the initial battery temperature value Bₒ and the initial coolant temperature value C₀.

Once the threshold amount of time t_{f} has passed, the control strategy 100 may continue to block 116 by ending the chiller mode. Next, at block 118, the control strategy 100 may compare the actual battery temperature profile ABT and the actual coolant temperature profile ACT to an expected battery temperature profile EBT and an expected coolant temperature profile ECT, respectively. The expected battery temperature profile EBT and the expected coolant temperature profiles ECT are experimentally created data or produced by measurement, test method experimental design, etc., and these profiles can be stored on the control module 78.

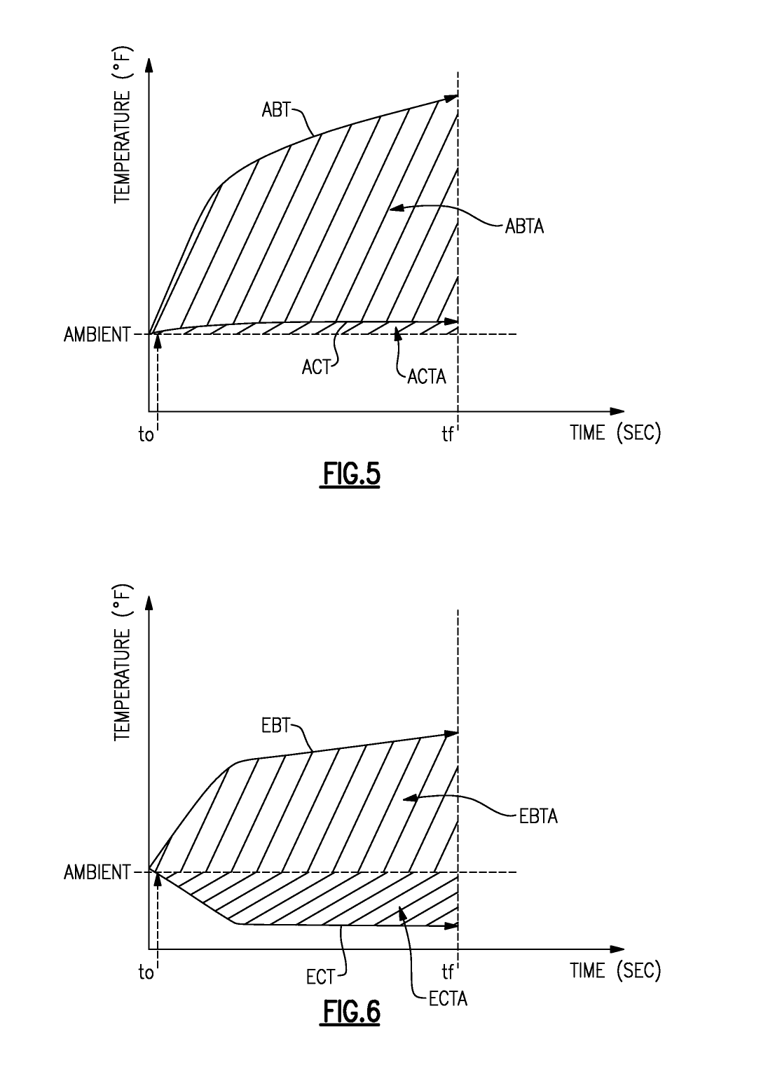

In one embodiment, the comparing step shown at block 118 includes performing discrete integration to calculate an actual battery temperature area ABTA and an actual coolant temperature area ACTA associated with the actual battery temperature profile ABT and the actual coolant temperature profile ACT. The actual battery temperature area ABTA and the actual coolant temperature area ACTA represent the area under the curves of the actual battery temperature profile ABT and the actual coolant temperature profile ACT (see FIG. 5). In one embodiment, the actual battery temperature area ABTA is calculated by integrating the change in battery temperature over time, and the actual coolant temperature area ACTA may be calculated by integrating the change in coolant temperature over time. An expected battery temperature area EBTA and an expected coolant temperature area ECTA can similarly be calculated based on the expected battery temperature profile EBT and the expected coolant temperature profiles ECT (see FIG. 6).

The comparing step of block 118 may next include calculating a difference between the actual battery temperature area ABTA and the expected battery temperature area EBTA, and a difference between the actual coolant temperature area ACTA and the expected coolant temperature area ECTA. These differences are compared to threshold temperature differences at block 120. For example, a battery temperature threshold difference BTD and a coolant temperature threshold difference CTD are stored on the control module 78 (see FIG. 4). If the difference between the actual battery temperature area ABTA and the expected battery temperature area EBTA exceeds the battery temperature threshold difference BTD, and the difference between the actual coolant temperature area ACTA and the expected coolant temperature area ECTA is less than the coolant temperature threshold difference CTD, then the control strategy 100 determines that the coolant pump 68 is OFF at block 122. Appropriate remedial actions may then be taken at block 124, such as by setting diagnostic codes, setting cluster lights/messages to alert customer, limiting power, or other remedial actions.

Alternatively, if the difference between the actual battery temperature area ABTA and the expected battery temperature area EBTA does not exceed the battery temperature threshold difference BTD, or the difference between the actual coolant temperature area ACTA and the expected coolant temperature area ECTA is not less than the coolant temperature threshold difference CTD, then the control strategy 100 determines that the coolant pump is ON at block 126. Appropriate remedial actions may be taken at block 128, such as by setting diagnostic trouble codes or other failure mode actions.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

We claim:

1. A method, comprising:
controlling a thermal management system of an electrified vehicle in a chiller mode to determine a running state of a coolant pump of the thermal management system.

2. The method as recited in claim 1, wherein the controlling step is performed in response to an electrical circuit fault.

3. The method as recited in claim 2, wherein the electrical circuit fault includes detecting a short to ground or an open circuit.

4. The method as recited in claim 1, comprising:
determining whether a battery temperature sensor and a coolant temperature sensor of the thermal management system are valid; and
saving an initial battery temperature value and an initial coolant temperature value.

5. The method as recited in claim 1, wherein controlling the thermal management system in the chiller mode includes:
circulating a portion of a coolant through a chiller loop;
commanding a coolant pump ON; and
opening a control valve to permit chilled coolant from the chiller loop to enter into an inlet of a battery pack.

6. The method as recited in claim 1, wherein the controlling step includes:
operating the thermal management system in the chiller mode for a threshold amount of time; and
ending the chiller mode after the threshold amount of time has passed.

7. The method as recited in claim 1, comprising:
comparing an actual battery temperature profile to an expected battery temperature profile; and
comparing an actual coolant temperature profile to an expected coolant temperature profile.

8. The method as recited in claim 7, comprising:
calculating an actual battery temperature area associated with the actual battery temperature profile;
calculating a difference between the actual battery temperature area and an expected battery temperature area;
calculating an actual coolant temperature area associated with the actual coolant temperature profile; and
calculating a difference between the actual coolant temperature area and an expected coolant temperature area.

9. The method as recited in claim 8, comprising:
determining that the coolant pump is OFF if a difference between the actual battery temperature area and the expected battery temperature area exceeds a battery temperature threshold difference and a difference between the actual coolant temperature area and the expected coolant temperature area is less than a coolant temperature threshold difference.

10. The method as recited in claim 8, comprising:
determining that the coolant pump is ON if a difference between the actual battery temperature area and the expected battery temperature area does not exceed a battery temperature threshold difference or a difference between the actual coolant temperature area and the expected coolant temperature area is not less than a coolant temperature threshold difference.

11. The method as recited in claim 8, wherein the actual battery temperature area and the actual coolant temperature area are calculated by performing discrete integration over a threshold amount of time.

12. A method, comprising:
operating a coolant subsystem of a thermal management system of an electrified vehicle in a chiller mode;
comparing an actual battery temperature profile to an expected battery temperature profile;
comparing an actual coolant temperature profile to an expected coolant temperature profile; and
determining a running state of a coolant pump of the coolant subsystem based on the comparing steps.

13. The method as recited in claim 12, wherein the operating step includes:
circulating a portion of a coolant through a chiller loop of the coolant subsystem;
commanding the coolant pump ON; and
opening a control valve of the coolant subsystem to permit chilled coolant from the chiller loop to be communicated to an inlet of a battery pack.

14. The method as recited in claim 12, wherein comparing the actual battery temperature profile to the expected battery temperature profile includes:
integrating the actual battery temperature profile to calculate an actual battery temperature area associated with the actual battery temperature profile; and
calculating a difference between the actual battery temperature area and an expected battery temperature area.

15. The method as recited in claim 12, wherein comparing the actual coolant temperature profile to the expected coolant temperature profile includes:
integrating the actual coolant temperature profile to calculate an actual coolant temperature area associated with the actual coolant temperature profile; and
calculating a difference between the actual coolant temperature area and an expected coolant temperature area.

16. The method as recited in claim 12, wherein the determining step includes:
determining that the coolant pump is OFF if a difference between an actual battery temperature area and an expected battery temperature area exceeds a battery temperature threshold difference and a difference between an actual coolant temperature area and an expected coolant temperature area is less than a coolant temperature threshold difference; or determining that the coolant pump is ON if a difference between the actual
battery temperature area and the expected battery temperature area does not exceed the battery temperature threshold difference or the difference between the actual coolant temperature area and the expected coolant temperature area is not less than the coolant temperature threshold difference.

17. A thermal management system, comprising:
a battery pack;
a coolant subsystem that circulates a coolant to thermally manage said battery pack, said coolant subsystem including a radiator, a coolant pump and a chiller loop; and
a control module configured to operate said coolant subsystem in a chiller mode to determine a running state of said coolant pump.

18. The system as recited in claim 17, wherein said coolant subsystem includes a valve that controls a flow of a chilled coolant from said chiller loop to said battery pack.

19. The system as recited in claim 17, wherein said chiller loop includes a chiller.

20. The system as recited in claim 17, comprising a refrigerant subsystem that exchanges heat with said coolant subsystem within said chiller loop.
